(19) United States
(12) Patent Application Publication
(10) Pub. No.: US 2007/0282561 A1
(43) Pub. Date: Dec. 6, 2007

(54) Apparatus and methods for sensing earth's inner ELF signals by an underground antenna

(76) Inventor: Robert W. Beckwith, Clearwater, FL (US)

Correspondence Address: Leo J. Aubel, 111 Rivershire Lane, Lincolnshire, IL, 60069, US

(21) Appl. No.: 11/799,915

(22) Filed: May 3, 2007

Related U.S. Application Data
(60) Provisional application No. 60/809,262, filed on May 30, 2006.

(51) Int. Cl. G06F 19/00

(52) U.S. Cl. 702/127; 702/1; 702/2; 702/14; 702/189

(57) ABSTRACT

A method and apparatus for forming an antenna extending downwardly into the ground, below the Earth's surface, for sensing the Earth's inner ELF (extremely low frequency) signals which signals are in turn useful in predicting earthquakes and volcanoes, and also sensing the intensity of said phenomena. More particularly, the inventive antenna is basically reversed in direction from conventional antennas.

### BACKGROUND OF INVENTION

This utility application claims the benefit of the filing date of provisional applications filed in the name of Robert W. Beckwith, which application was filed on May 30, 2006 and accorded Ser. No. 60/809262. Application Ser. No. 60/809262 was titled “Apparatus and Methods of Obtaining Information About the Earth's Extra Low Frequency (ELF) Signals from a Hole-In-The-Ground (HITG)”, let us define ELF signals as being at any frequency from 30 cycles per second (CPS) down to and including those with periods of 24 hours and 12 months.

Various researchers have been looking for Tesla Schumann (TS) frequency, occurring above the Earth, calculated to be 7.8 hertz and which is due to the combined effect of lightning strokes over the entire Earth and the magnetic field of the Earth. Antennas that are several miles long have been built to sense the Earth's TS signals mentioned above and some success has been reported.

One embodiment of the antennas previously used by the inventor to detect TS signals is shown in FIG. 1 wherein separate spaced coils 2, 3 and 4 are coiled around an iron strap or rod 1. Rod 1 is about 20 ft in length and positioned on the Earth's surface 10. Coils 2, 3 and 4 are connected in series by wires 6 and 7. The wires 5 and 8 of FIG. 1 were connected to a receiver built in accordance with U.S. Pat. No. 6,411,9113 issued to Robert W. Beckwith, the inventor herein. Attempts were made to orient the antenna of FIG. 1 at different directions with respect to North in search for the TS frequency, but all attempts were unsuccessful.

The inventor attempted to use various voltages such as 120 VAC and 240 VAC to act as an antenna to separate the TS frequency from ground potential and it was recognized that no such separation exists. The entire above the Earth interconnected power system acts as a single ground for all signals below 30 Hz.

If no such separation exists from the Earth upward, the inventor asked himself: I wonder if there are any signals from the power system ground downward into the Earth. In conducting the experiments, the inventor realized that all of the electric power lines of all voltages short out the low frequencies from 30 Hz to zero Hz. Note that electric power frequencies are given in Hertz (Hz) and Earth's electromechanical signals in cycles per second (CPS).

The Hole In The Ground (HITG), under the ground antenna structure, of FIG. 2 was the result of the foregoing analysis. The antenna of FIG. 2 will be described in detail herein below.

### SUMMARY OF THE INVENTION

A method and apparatus for providing an antenna structure formed and constructed to extend downwardly below the Earth's surface are disclosed. In one embodiment of the invention, a non-conductive casing is embedded into the ground and an associated conductive tubing is positioned to extend downwardly within the length of the casing. Magnesium sulfate and conductive metallic pieces are introduced into the casing and dropped into the casing and thus to the ground around the lower end of the casing to enhance electrical contact with the ground beneath and around the lower end of the casing. Electrical connection is made to the conductive tubing through the metallic pieces and the magnesium sulfate to sense ELF signals occurring in and through the surrounding ground. Spectrum analyzers are used to detect and display ELF signals.

The foregoing features and advantages of the present invention will be apparent from the following more particular description of the invention. The accompanying drawings, listed herein below, are useful in explaining the invention.

### DESCRIPTION OF DRAWINGS

FIG. 1 labeled prior art is a depiction of an antenna structure used by applicant in previous research;

FIG. 2 is a view of one embodiment of the present invention wherein an antenna is embedded in the ground in a shallow position;

FIG. 3 shows a spectrum of signal spikes between 2.5 and 25 cycles per second obtained using the “Hole In The Ground (HITG) under the ground antenna of FIG. 2;

FIG. 4 is a view of an apparatus structure illustrating the basic principle of the present invention depicting an antenna extending downwardly below the Earth's surface; and

FIG. 5 depicts a more detailed embodiment of the invention wherein the antenna extends deep into the ground.

### DESCRIPTION OF THE INVENTION

Refer now to FIG. 2 for a detailed description of an operating embodiment of the inventive underground antenna structure. The antenna structure generally labeled 9 includes a plastic casing 18 having a plurality of sections 18A, 18B, and 18C. The number of sections depends on the depth to which the casing 18 is to be embedded. The casing sections are joined together to form the desired length of the casing 18. The casing 18 of the embodiment of FIG. 2 was jetted (water pressure driven) using a garden hose 16 since the ground soil on which the antenna was located was a relatively soft type of sandy soil. In harder soils drilling of the associated hole is required.

The casing 18 is available in various lengths and in the embodiment of FIG. 2, it is PVC plastic pipe of one inch nominal inside diameter. The multiple pipe sections making up casing 18 are joined in situ to obtain the total length of pipe 18.

The section of 18C, which is a T-section, connects to water valve 14 and on to connector 16 enabling making temporary connection to a garden hose 17. Water under pressure from the hose permits the casing 18 to be jetted into sand with pipe sections added as needed to form the vertical portion of casing 18. In the embodiment of FIG. 2, the casing 18 is about twenty feet (20) in length.

A one half inch diameter copper pipe 15 is inserted and lowered into the casing 18. The pipe 15 extends down the full length of the casing 18. The copper pipe may comprise different sections which are joined or soldered together.

After casing 18 and pipe 15 are in place, water is introduced to casing 18 through water regulator valve 14 hose connection 16 and garden hose 17. The water is allowed to go up to the top of the T-section 18C. A funnel 29 is temporarily mounted atop the T-section 18C and then magnesium sulfate 20 is poured through the funnel into the water filled casing. The water and magnesium sulfate 20 are allowed to soak the ground for one half hour to one hour. The magnesium sulfate soaked ground 21 is indicated by the cross hatching in FIG. 2. It is known that magnesium sulfate can be used to form a low impedance to electrical ground without corroding copper pipe 15.

Next several pounds of stainless steel nuts 19 (of about a #8 size) are introduced through funnel 29 into the casing 18. The stainless steel nuts 19 will settle down to the bottom or lower end of casing 18 and into the region of ground 21 beneath the casing 18 which is soaked with magnesium sulfate. As shown in FIG. 2, the stainless steel nuts will be in physical contact with the copper pipe 15 and will provide a low dc resistance to the copper pipe 15. The copper pipe 15 will thus have good electrical contact to region 21 soaked in magnesium sulfate and containing the stainless steel nuts 19.

After the magnesium sulfate 20 and stainless steel nuts 19 have been introduced into the casing 18, funnel 29 is removed from the casing and a cap 30 is fastened onto T-section 18C that forms the top of casing 18. The water introduced through the hose 17 will drain away to the ground water level.

To complete the installation of the copper pipe 15, the upper end of the pipe 15 is connected to bolt and nut assembly 12 that is mounted on the casing T-section 18C. Assembly 12 is connected to the center conductor 25 of an RG-58/U coaxial cable 26 leading into building 27. Electric current signals between pipe 15 and electrical ground 28 are connected to electronic equipment for processing. Cable 26 end connector 23 is left disconnected to avoid circulating currents being introduced into the sheath of cable 26.

The embodiment of FIG. 2 was installed on the grounds of the Beckwith Electric Co. (BECO) complex located in Largo, Fla. The building 27 is an steel frame structure. A copper wire 22 is connected from the sheath of RG-58/U cable 26 to building 27 ground 28;

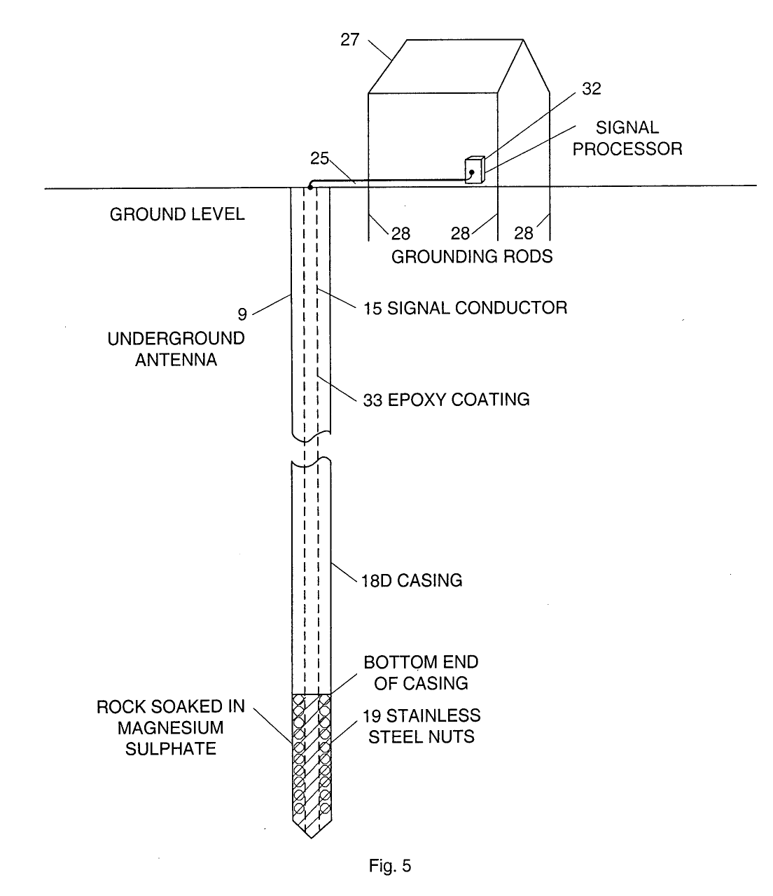

The ground and neutral lines of electric power systems (utilities) in the USA are connected together and to electrical ground rods. These ground/neutral connections are carried across the United States and through interconnected electric power systems to the North and to the South of the USA. Connection to this ground reference is made to the steel frame of the building 27 (shown in FIGS. 2 and 5) to which the electric power systems neutral/ground is connected. The impedance of these electrical grounds is quite low in the ranges from DC to frequencies of 30 Hz and this forms a ground reference for ELF signal waves.

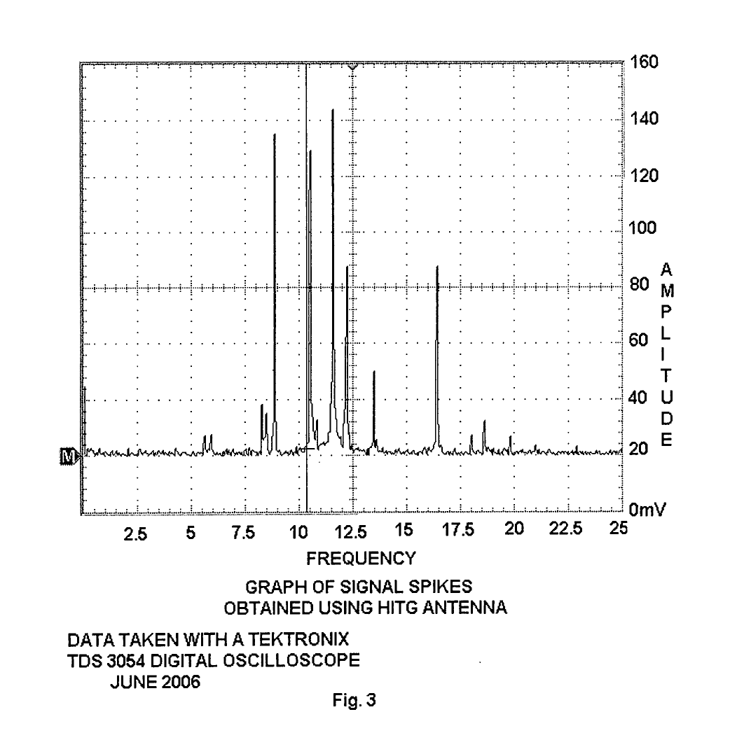

In the embodiment of FIG. 2, a Textronic TDS3054 digital oscilloscope was connect between ground and the output connects 23 of coaxial cable 26 from the HITG underground antenna. This oscilloscope has separate modes for time and for frequency spectrum outputs. Snapshot of the spectrum modes are stored on a floppy disc, when called for. Floppy discs can be put into an external computer for display, adding frequencies, amplitudes, time and date for printing results such as FIG. 3.

The source impedance was measured by placing resistors of varying size across the spectrum analyzer until the spectral peaks were lowered by a factor of two as compared to no resistors. It is well known that matching a generator source impedance with a load of equal value will extract maximum energy from the generator. From this a source impedance of 62.5 ohms is calculated.

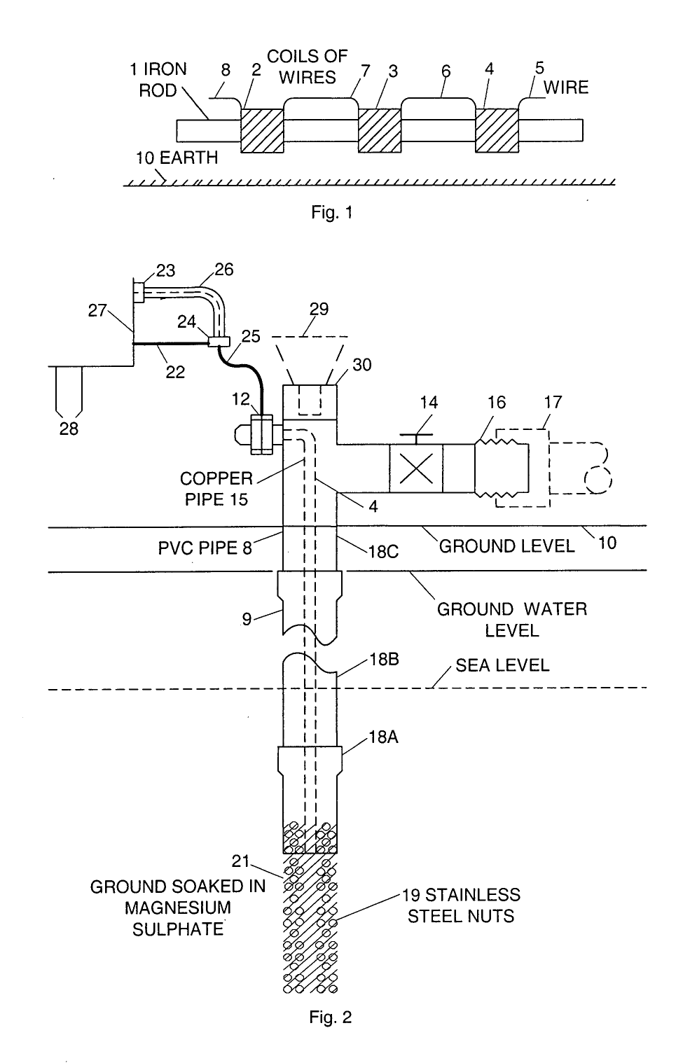

The rms voltage for the peaks of FIG. 1a was calculated using the following table of amplitudes:

| Frequency Hz | Amplitude millivolts |
|---|---|
| 5.56 | 37 |
| 8.0 | 08 |
| 8.69 | 78 |
| 10.3 | 40 |
| 10.8 | 35 |
| 11.5 | 68 |
| 11.9 | 16 |
| 13.5 | 13 |
| 5.75 | 16 |
| 19.75 | 05 |

The total rms voltage is the square root of the sum of the squares of above 10 amplitudes or 150.18 mV.

By dividing the voltage by the resistance a current of 2.4 milliamps is obtained. By multiplying voltage and current an output power of 0.361 milliwatts is obtained.

Tests of the antenna FIG. 2 obtained results as shown in the graph of FIG. 3. As stated above, the graph shows signal spikes between 2.5 and 25 cycles per second. The inventor was pleased to see a spectrum never before seen or predicted. Work is ongoing in attempts to correlate spectrum peaks such as shown in FIG. 3, with events provided by the United States Geological Survey. Such events include earthquakes and volcanic eruptions. It may be that eruptions of the Krakatoa volcano and certain earthquakes have already been seen. A more practical spectrum analyzer obtained in May 2007 is an AARONIA Model Spectran NS-5020 Spectrum Analyzer Blue Tooth output to a computer for display or printing.

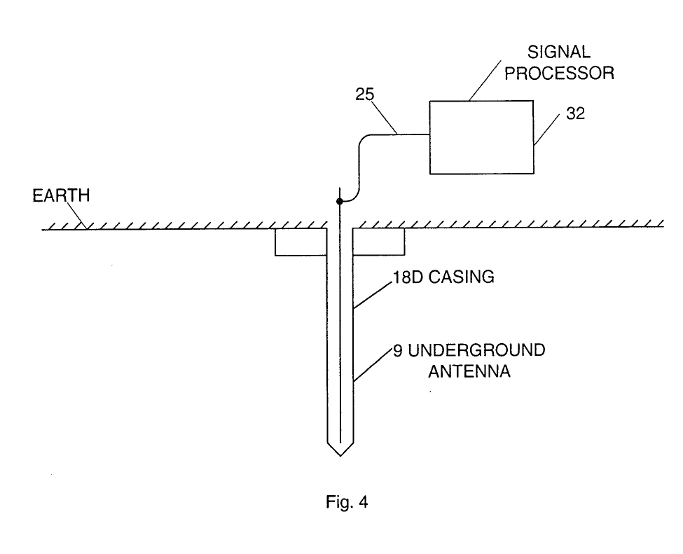

Refer now to FIG. 4 which shows a basic principle of the inventive antenna 9. In contrast to prior art antennas, antenna 9 extends downwardly into the Earth (i.e. below the Earth's surface). The antenna is positioned within an electrically insulated casing 9A that is embedded in a hole drilled into, and extending into or below the Earth's surface. The depth of the hole, and of the antenna, may be of any selected length; the inventor contemplates that the antenna may be down to 2000 feet in depth.

The antenna 9 is intended to detect Earth's inner ELF signals developed in and through the various layers of the Earth. As shown in FIG. 4, the output of the antenna 9 is connected through lead wire 9C to signal processing equipment 9B. The subject underground antenna is intended to detect and sense the electro mechanical phenomena, that is the sensing of the cps (cycles per second) of signals created by the eruption of volcanoes and the Earth's crust. Changes produced by earthquakes and has as one purpose, the prediction of earthquakes.

Refer now also to FIG. 5. The apparatus of FIG. 5 is essentially a more detailed view of FIG. 4. Deep holes 9A with insulated casings 18E are drilled into the Earth at various locations and depths to investigate each particular region and the ELF signals occurring in that region. The antenna 9 comprises a signal conductor pipe, rod or tubing 15 positioned within the casing 18. The stainless steel nuts 19 and the magnesium sulfate soaked region 21 are as described above for the embodiment of FIG. 2. The antenna 9 of FIG. 5 thus comprises a conductive pipe or wire 15 insulatively positioned in the insulated casing 18D positioned deep in the Earth. The upper end of the conductor 15 is connected via wire 25 to signal processing equipment 32 in an associated building 27. Grounding rods 28 provide the electrical ground, similarly as in FIG. 2. Note that conductive pipe or wire 15 may be insulated by a coating of epoxy 33 and will extend below the bottom end of casing 18D. The casing is likely steel pipe at electrical ground potential. The extended hole beneath the lower end of casing 18D contains magnesium sulfate 20 and stainless steel nuts 19 for picking up ELF signals.

While the invention has been particularly shown and described with reference to preferred embodiments thereof, it will be understood by those skilled in the art that various changes in form and details may be made therein without departing from the spirit and scope of the invention.

### Advantages of the Patented Equipment

1. Develops new knowledge of electromechanical signals circulating under the Earth.
2. Changes in the electromechanical signals may help understand global warming and other long range effects of the weather.
3. Signals from earthquakes may warn of oncoming earthquakes.
4. Signals from volcanoes may warn of oncoming eruptions.

1. The method of using underground antennas for obtaining underground signals the method comprising the steps of;
a) extending holes under the surface of the Earth for holding insulating tubing,
b) assembling lengths of PVC pipe for forming said tubing,
c) connecting a hose with water under pressure for jetting said tubings to desire distances below local ground water levels,
d) placing conducting pipes through said tubings for sensing underground signals,
e) using connections to the electric power system ground as ground reference for said underground signals, and
f) using spectrum analyzers for displaying underground signals.

2. A method as in claim 1 further comprising the steps of:
a) using magnesium sulfate to lower the resistance between said pipes and the Earth, and p1 b) using stainless steel nuts for further lowering the resistance between said pipe and the Earth.

3. A method of sensing ELF signals developed by the Earth comprising the steps of:
a) embedding non-conductive casings into the ground to a selected depth,
b) placing conductive tubing within the length of said casings to about the depth to which said casings are embedded,
c) allowing said conductive tubing to form underground antenna to sense ELF signals developed in said region, and
d) connecting said ELF signals via said antenna to ELF signals sensing instrumentation.

4. An underground antenna for sensing ELF signals developed by the Earth comprising:
a) non-conductive casing embedded in the ground to a selected depth,
b) conductive tubing extending within and along the length of said casings to a depth of about the lower end of said casings to function as underground antennae, and
c) electrical wire connecting the upper end of said antennae to ELF signal sensing means.

5. A method of sensing ELF signal developed by the Earth comprising the steps of:
a) embedding non-conductive casings into the ground to a selected depth,
b) placing conductive tubing within the length of said casings and about to the depth to which said casings are embedded,
c) pouring magnesium sulfate or other chemical for inducing electrical conductivity into the Earth,
d) pouring conductive metallic particles into said casing for enhancing said electrical conductivity,
e) enabling said conductive tubing to sense ELF signals, and
f) connecting said ELF signals from said tubing to signal sensing instrumentation.

6. Apparatus for sensing ELF signals comprising:
a) non-conductive casings embedded in the ground to a selected depth,
b) conductive pipe extending within and along the length of said casing to a depth of about the lower ends of said casings functioning as antennae to sense ELF signals,
c) electrical wires connecting upper end of said conductive tubing to ELF signal sensing means,
d) conductive metallic and chemical substances for assuring good electrical connection with selected minimal impedance between the surrounding ground and said conductive pipes, and
e) laboratory instruments connecting to said conductive pipes for sensing said ELF signals.

7. A method as in claim 3 further including the steps of:
a) filling said casing with water and letting said water and letting said water soak the soil beneath and around the lower end of the casing, and
b) pouring magnesium sulfate through the water in said casing to permit said magnesium sulfate to settle through the water to soak the soil beneath and surround the lower end of said casing to provide an electrically conductive region.

8. A method as in claim 7 wherein said metallic particles comprise stainless steel nuts to enhance the electrically conductive properties of the region.

9. Apparatus as in claim 3 means temporarily coupling funnels to the top of said casing to permit chemical and mechanical particles to be poured down said casings.

10. Apparatus as in claim 9 including connector assemblies connecting to said copper tubing, cabling for connecting said copper tubing to associated electronic instrumentation located in an associate steel structure building, said instrumentation for sensing signals developed in said tubing, and means for providing an electrical ground to said apparatus referenced to said building electrical ground.

11. A method as in claim 8 wherein the casing is jetted down to a selected depth below the fresh water level of the area.

12. A system comprising well type structure for sensing ELF signals comprising in combination:
a) non-conductive casings embedded in the ground to a selected depth,
b) conductive tubing extending along the length of said casing within said casing to a depth of the lower end of said casing,
c) means for enhancing the electrical conductivity of the region beneath and around the lower end of said casing, and
d) electrical wiring connecting the upper end of said conductive tubing to ELF signal sensing instrumentation.

13. A method as in claim 11 wherein said casing is embedded into the ground to a position where said lower end of the casing is below the local water level.

14. A method of sensing ELF signals developed by the Earth consisting of locating underground antennas at various spaced sites to sense the inner Earth's ELF signals at each particular site, and providing communications between said spaced sites, and a central control to correlate the data obtained at the said sites to thereby sense and possibly predicate earthquakes, volcanoes, and other violent Earth phenomena.

15. An apparatus for sensing the Earth's inner ELF signals comprising an antenna that extends below the surface of the Earth's crust.

16. Apparatus as in claim 15 wherein and said antennae use the electric utility power system electrical ground as its electrical ground.
